(19) United States
(12) Patent Application Publication
(10) Pub. No.: US 2007/0208725 A1
(43) Pub. Date: Sep. 6, 2007

(54) Displaying common operational pictures

(76) Inventors: Mike Gilger, Satellite Beach, FL (US); Kerry Gilger, Indialantic, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/406,774

(22) Filed: Apr. 19, 2006

Related U.S. Application Data
(63) Continuation-in-part of application No. 11/367,789, filed on Mar. 3, 2006.

(51) Int. Cl. G06F 17/30

(52) U.S. Cl. 707/4

(57) ABSTRACT

A plurality of knowledge enhanced graphical symbols are utilized to represent a display element type when displaying a common operational picture. Plural instances of such a display element type allow rapid visual assessment of the situation displayed on the common operational picture by permitting a user to rapidly identify instances which are abnormal or problematic. Individual knowledge enhanced graphical symbols may aggregate information from other knowledge enhanced graphical symbols and other knowledge enhanced graphical symbols may be utilized to change the state of data in a database from which information about the common operational picture is derived.

### CROSS REFERENCE TO RELATED APPLICATIONS

This application is a continuation-in-part of Ser. No. 11,367,789, entitled Expanded Graphical Interface For Information Cognition, by inventors Mike Gilger and Kerry Gilger, filed Mar. 3, 2006, which is hereby incorporated by reference in its entirety into this application.

### BACKGROUND OF THE INVENTION

1. Field of the Invention

The invention is directed to improvements in information display and more particularly to improvements in display of a common operational picture (COP).

2. Description of the Prior Art

The Global Information Grid (GIG) enables the dissemination of real-time data from large numbers of sensors/sources as well as the distribution of that data immediately to recipients across the globe, resulting in better, faster, and more accurate decisions, reduced operational risk, and a more competitive war-fighting advantage. As a major component of Network Centric Warfare (NCW), the GIG seeks to provide the integrated information infrastructure necessary to connect the robust data streams from ConstellationNet, FORCENet, and LandWarNet to allow Joint Forces to move beyond Situational Awareness and into Situational Understanding. NCW will provide the Joint Forces a common situational understanding, a common operational picture, and any and all information necessary for rapid decision-making. However, with the exception of the 1994 introduction of the Military Standard 2525 “Common Warfighting Symbology,” there has been no notable improvement in our ability to display information on the common operational picture for accurate and rapid understanding.

### PROBLEMS OF THE PRIOR ART

The prior art possesses a serious problem in that it is not clear how one can display newly integrated data being thrown at a user, such as a war-fighter user, so that the user won't be over whelmed by the information. This constitutes a significant human machine interface challenge.

### BRIEF SUMMARY OF THE INVENTION

The invention is directed to improvements in displaying common operational pictures so that information will be readily understood by a user and enable the user to overcome the problems associated with the prior art discussed more hereinafter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a high-level system diagram representing a global information grid of the prior art.

FIG. 2A is an image of a plurality of friendly and hostile targets displayed on a map overlay as in the prior art.

FIG. 2B is a representation like FIG. 2A, but with targets enhanced to better stand out against the background.

FIG. 3 shows the image of FIG. 2A with a target tracking display utilized to display information about targets in an area of interest on the display screen.

FIG. 4 shows the display screen of FIG. 3 with the addition of a target promoting display overlaid on the right half of the display screen.

FIG. 5 shows a display screen of FIG. 4 with the addition of an alert dashboard in the upper left hand corner of the display screen.

FIG. 6 shows the display screen of FIG. 5 with the addition of two chat room session windows which, with other displays, complete the loss of situational awareness (SA) on the part of a user.

FIG. 7 illustrates a Kegset™ for replacing the displays that obscured and operators situational awareness in accordance with one aspect of the invention.

FIG. 8 illustrates exemplary semantics associated with the “Priority” KEGS® associated with the Kegset™ of FIG. 7 in accordance with one aspect of the invention.

FIG. 9 illustrates exemplary semantics associated with the “TST and Late” KEGS® of the Kegset™ of FIG. 7 in accordance with one aspect of the invention.

FIG. 10 illustrates exemplary semantics associated with the “TCO Status” KEGS® of the Kegset™ of FIG. 7 in accordance with one aspect of the invention.

FIG. 11 illustrates exemplary semantics associated with the “CDE” KEGS® of the Kegset™ of FIG. 7 in accordance with one aspect of the invention.

FIG. 12 illustrates exemplary semantics associated with the “(SODO)/(SIDO)/(SOF)/(BCD)” KEGS® showing the use of an aggregating KEGS® and exemplary semantics for each KEGS® forming the aggregate KEGS® in accordance with one aspect of the invention.

FIG. 13 illustrates how an authorized user can change the state of the KEGS® associated with his command in accordance with one aspect of the invention.

FIG. 14 illustrates exemplary semantics for each of the “(CM)”, “(PID)” and “(MSN)” KEGS® of the Kegset™ of FIG. 7 in accordance with one aspect of the invention.

FIG. 15 shows a Kegset™ that is designed to be used in a common operational picture to represent one of possibly many facilities to monitor the supply chain status of each facility.

FIG. 16 illustrates a set of semantics suitable for use with the common operational picture of the state of the possibly many facilities referred to in FIG. 15.

FIG. 17 shows a COP of status of a motor driven pumping station.

FIG. 18 shows a COP of the status of 5 sales regions.

FIG. 19 shows a COP of the status of international routes.

FIG. 20 shows a COP of a helicopter with the status of several important systems represented by Kegset™.

### DETAILED DESCRIPTION OF THE INVENTION

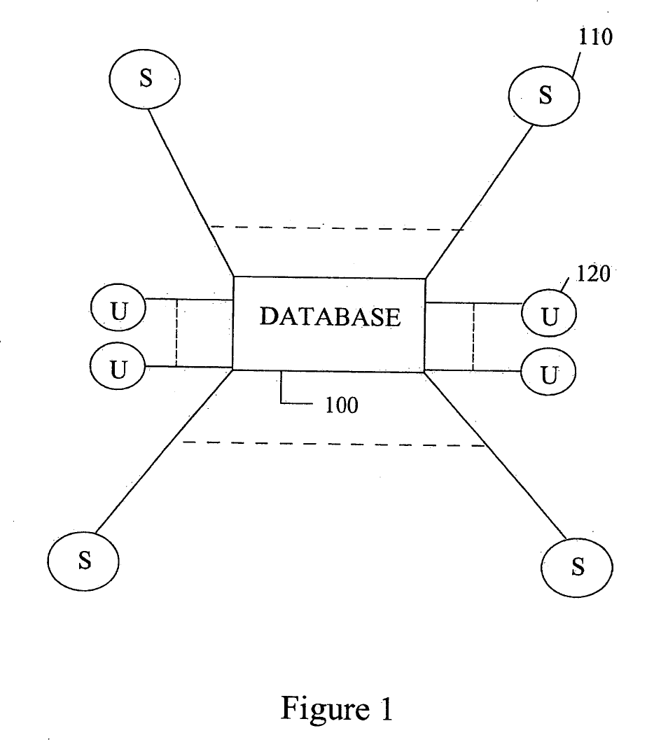

FIG. 1 is a high-level system diagram representing a global information grid as utilized in the prior art. A plurality of sensors 110 are located throughout the world. A sensor may be a transducer of various sorts or a human source which communicates information regarding its status or its perception to a common database 100. Sensors can include real time satellite image or images from unmanned aerial vehicles. In short, any source of information that may contribute to a situational awareness needed by a user at any location within the world is considered a sensor of the type illustrated of 110.

A plurality of users, 120 have access to the database 100. Each user may have a different need for information in order to fulfill their role in, for example, network centric warfare.

Network Centric Warfare (NCW) is characterized by a collection of warfighting concepts and related military capabilities that facilitate the warfighter's abilities to leverage all available information from numerous sensors and sources to make better and faster decisions with less risk.

The tenets of NCW dramatically increase mission effectiveness. They are:
That a robustly networked force improves information sharing
That information-sharing enhances the quality of information and shared situational-awareness
That shared situational-awareness enables collaboration and self-synchronization, and enhances sustainability and speed of command

Network Centric Operations (NCO) provide today's armed forces with access to a tremendous amount of information. When this network information is combined with intra/extra-force networking, warfighters have a significant information advantage. The central hypothesis of NCW is that a force with these networked capabilities can increase combat power by:
Improving synchronizing-efforts in the battlespace
Achieving greater speed of command
Increasing lethality, survivability, and responsiveness

Key to NCW success is the ability to fuse large command, control, communications, computers, intelligence, surveillance, and reconnaissance (C4ISR) systems together to formulate an overall picture, with the emphasis on battlespace knowledge and shared situational awareness among our forces, as well as our coalition forces.

But one of the key constructs of NCW is interoperability—sharing data among the various forces through the use of computer networks. Networks provide access to tactical and strategic data needed to help organizations align strategic and operational objectives with business activities through smarter decisions and actions for greater success. Networks also provide an actionable channel for dissemination—allowing the goals and directives to be communicated quickly throughout the organization. For the military, significant synergy can be achieved by simultaneously linking and sharing information in a common operational environment where warriors, sensors, networks, command and control, platforms, and weapon systems all interact and work together in large C4ISR systems.

Unfortunately, the progress in this area has been painful, as each of the services has implemented its own information-architectural frameworks for integrating its systems. Independent production and development of these frameworks has caused significant interoperability issues between the services because the systems were produced in a stovepipe and do not integrate into an overall system. (The Air Force has C2 Constellation, the Marines' have the Marine Corps Integrated Architecture Picture, the Navy has ForceNet, and the Army uses LandWarNet.) The services have also developed their own information displays that are incompatible with each other. In order to realize the full potential of NCW, these network architectures and displays must become fully interoperable.

One way that the services have attacked this problem is through the creation of the Globally Interconnected Grid (GIG) (defined in DODD 8100.1). Made up of complex information networks, the GIG is the technical vehicle of NCW. Its objective is to attain a more fully integrated, joint command, control, communications, and computer capability (C4). It is designed to provide warfighters with secure global access to information and to integrate older messaging systems, such as the Defense Message System (DMS), Global Command and Control System (GCCS), and the Global Combat Support System (GCSS).

The GIG supports DoD and related intelligence community missions and functions, and provides communications interfaces to coalition, allied, and non-DoD users and systems (from peacetime business activities through all levels of conflict).

The GIG provides interoperability at the strategic, operational, tactical, and base/post/camp/station levels. When the GIG is fully realized, it will integrate each of the services' information-architectural frameworks (C2 Constellation, Marine Corps Integrated Architecture Picture, ForceNet, and LandWarNet) into a combined information stream aimed at simplifying the planning and execution processes. The information supplied by these frameworks is to be merged into a common operational picture (COP)—in this case a coherent picture of the battlefield. Linking these frameworks through the GIG allows the military to jointly plan and execute operations, thus saving time and benefiting from the input of multiple “sensors,” both system and human.

However, there is concern about the level of effort applied to the information technology (IT)—information availability and delivery—aspects of NCW. Critics charge that the bulk of NCW's focus has been on IT, while the information itself, as well as the warfighter's ability to process the information, receives very little attention.

The military services face challenges in achieving faster information-dissemination and decision-making cycles not only because they created their systems independently, but also because their ability to produce information is far outpacing their ability to distribute and display the information in a meaningful way to the warfighter. It is expected that this data surplus—provided by the new information streams from the GIG—will overwhelm the current display technologies used to present the data to the warfighter.

Decisions need to be made in high tempo and highly hostile operating environments. In order to take on the challenges of the battlefield and fight in a Network Centric Scenario, NCW needs to provide a coherent, consistent, and clear view of the battlespace—containing actionable, accurate, up-to-date information, with the goal of achieving decision superiority during combat operations.

The history of operations in the Persian Gulf demonstrate that warfare will most likely become more coalition-based, which will increase the need for interoperability.

Sharing information adds considerable complexity to the information dissemination as it is expected that all command levels will receive the same picture of the situation—including integrated coalition partner information. Players (sensor, shooter, commander) that are synchronized and optimized into a single action are fundamental to a successful Network Centric Operation (NCO).

The key to gaining shared situational awareness is to create a display that merges C4ISR data into a single, customized picture. Decisions-makers in different geographical locations and at different levels of command should be able to view this picture and gain the same situation understanding of the battlespace. This is accomplished through the use of the common operational picture (COP).

The COP is the integrated capability to receive, correlate, and display a common tactical picture. Sensors and people can identify and disseminate, via the network, the state of the battlespace as it develops. The obvious concern is how much data can the COP display without overwhelming the warfighter, or causing him to lose situational awareness? Currently, the COP includes data such as:
Planning applications and theater-generated overlays/projections (which can include location of friendly, hostile, and neutral units; assets; and reference points)
Battle Plans
Force Position Projections

The COP can include information relevant to the tactical and strategic level of command.
Geographically-Oriented Data
Planning data from Joint Planning and Execution System (JOPES)
Readiness data from Status Of Resources And Training (SORTS)
Intelligence (including imagery overlays)
Reconnaissance data from the Global Reconnaissance Information System
Weather from Meteorology and Oceanography (METOC)
Predictions of nuclear, biological, and chemical fallout
Air Tasking Order data

It is obvious that the increasing number of sensors and databases presents a huge challenge. Visualization technologies used within the COP have not kept pace with the significant increase in data volume or data types. It would appear that there have been no notable improvements in the ability to display information for rapid understanding with the possible exception of the 1994 Military Standard 2525 “Common Warfighting Symbology.” (Adding more arrows, shading, or other clues would do little to add essential information to the COP.)

Current COP visualization technologies fall short when it comes to displaying critical mission-status-details such as time sensitive and high priority target designators, potential collateral damage assessments, the current state of the target-identification workflow, or even the status of the asset assigned to eliminate the target (assigned, in route, engaged, pending damage assessment).

Without an effective information visualization capability, the COP is unable to meet its NCW objectives of providing all users the same situational awareness at the same time to foster collaboration, enhance decision making, and accelerate the “speed of command.”

The issues plaguing the COP display are the same issues that plague most information displays. From business dashboards to control-room displays, appropriate information visualization can either make the operator's work more manageable, or they can cause the operator to work harder and experience stress during task execution. The goal is to create a visual display that presents (the structure and relationships within) a data set in an effective format that is easy (quick) to interpret and understand. But there are two opposing constraints that make this goal difficult: (1) Most problems we want to visualize have multiple dimensions of data that require vast real estate for visualization, and (2) The real estate available for visualization of that data is very finite. Strides are being made in manufacturing larger and more dense display systems. However, the reality is that the visual perception space of the human eye establishes a limit on visual real estate, a limit which confines our focus to the multiple dimension constraint.

There are a large number of tabular and graphic display elements including line graphs, bar charts, pie charts, scatter plots, matrices, tables, networks, and maps. Despite the variety, they are all relational information displays—displays that represent relations between dimensions of data. A significant issue in presenting diverse information with relational-graphical display elements is the variation in scales and data types that represent the various dimensions of data. Scale and data types constrain graphical display elements to a limited number of data dimensions that they can effectively display. When a display requires three or more dimensions of information, it can quickly become difficult to interpret. When a graphic display requires two or more dimensions of unrelated data types, then the display cannot be constructed with a single graphical display element. It requires more display real estate—which has already been identified as finite.

The multiple dimension issue is exacerbated since NCW decision-makers, like any business decision maker, typically require far more than two or three dimensions of data to make accurate decisions. Also, these dimensions typically use different data types, scales, and ranges, which force the use of multiple graphic display elements to create a display. The desire is to create a single graphical display element that can represent all the data-dimensions necessary to make a decision. This allows for data-proximity benefits (allowing all the data necessary to make a decision to be viewable in one area), and it further reduces the negative effects of context switching (forcing the operator to remember aspects of the data while he browses and/or searches through other displays for more data). Therefore, due to their weakness in multi-dimensional data representation (requiring more graphic elements to represent more dimensions) relational-based graphical elements should be limited within displays.

The text-based table is an example of a small viewable area, but text is expensive—both on processing time within the human mind (recognizing text can be cognitively expensive), as well as its heavy use of real estate for display. For rapid interpretation of information, researchers have found that graphical displays outperform text displays. Researchers have compared pie charts, bar graphs, and tables; and found a definite advantage for graphical displays. They found that tables are easier to make than graphs, and can be more effective if the goal is to read exact numbers. However, the data can be seen much more clearly in a well-chosen graphical display when the purpose of a display is to quickly show the “state” of the data vs. an explicit value. For example, it is much faster to comprehend constructs such as too fast, too slow, no fuel, or no weapons rather than comprehending the specific values of the data such as 100 mph, 200 rpm, 30 gallons, 0 air-to-air missiles. When the operator has to interpret the specific values, it adds to the time for comprehension. However, in most cases, overloading the operator with specific values provides no benefit to their understanding of the data.

One of the factors that improved performance for graphical displays is reduced cognitive loading—the amount of “thinking” that must be done prior to achieving an understanding of the display. Graphical displays reduce the amount of cognitive processing in several ways. First, they can show multi-dimensional data that is relevant to the cognitive task—within reason, too much is distracting, too little is insufficient for full understanding. Second, they reduce the “search” time for gathering required information for a decision—good visualizations reduce search by reducing the number of items that the operator must view in order to gather the required information, sometimes grouping related data items in a single area of the display. And third, they allow operators to replace difficult logical constructs with easier-to-process visual constructs. Examples of visual constructs are differentiating shapes and colors vs. examples of logical constructs such as computing distance between two tracks, or determining the effective kill range of specific armaments.

Cognitive studies by Pinker and Kosslyn show that graphs generally reduce cognitive loading (holding values in working memory, trying to remember dimensions of the data, etc.), because the visual perception system takes over some of the work (providing a structural description), resulting in higher accuracy for complex data. Therefore, due to its expensive nature—in real estate and in cognitive loading (recognition and comprehension time)—textual based elements should be limited or removed entirely from displays if possible.

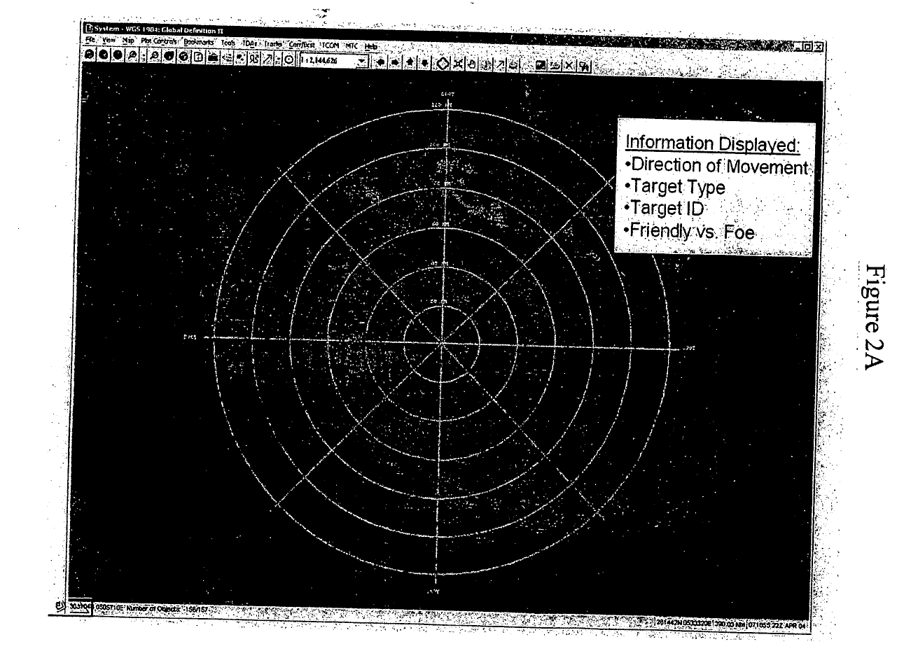

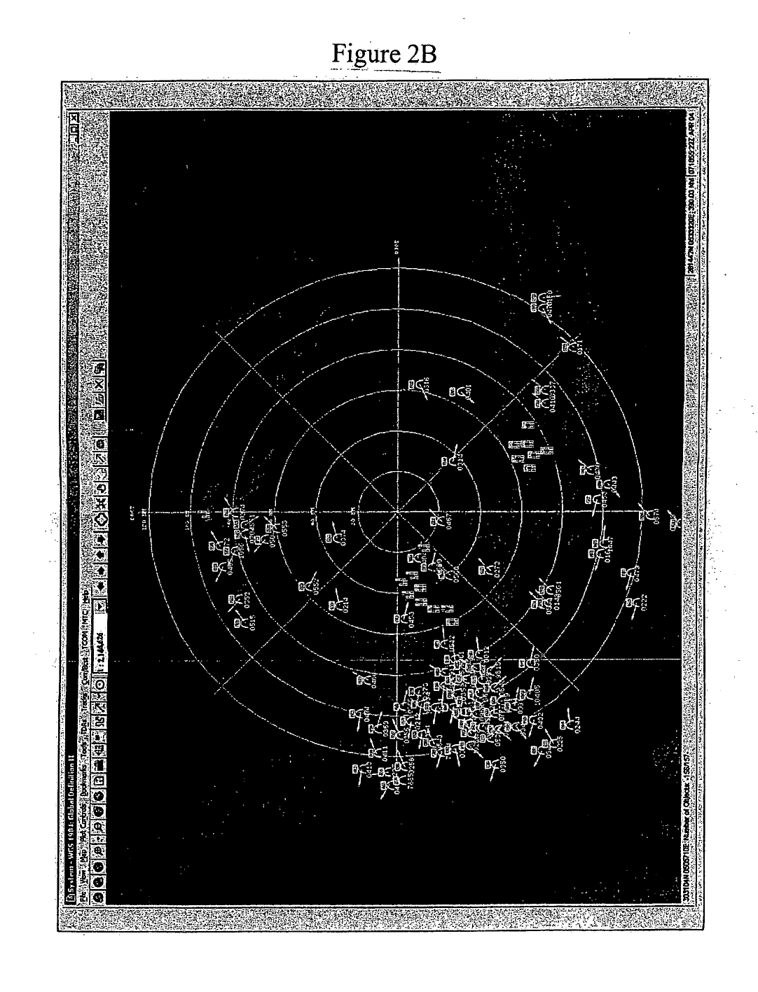

FIG. 2A is an exemplary image of a plurality of friendly and hostile targets displayed on a map overlay as might occur in displaying NCW data gathered over the GIG, using MIL-STD-2525 symbology. There dimensional symbols can be used as replacements for the MIL-STD-2525 symbology.

FIG. 2B is a representation like that of FIG. 2A but with targets enhanced to better stand out against the background.

In 1993 the “Defense Information Systems Agency” (tasked by the Military Communications Electronics Board) initiated a project to standardize warrior symbology. Military Standard 2525, Version 1, “Common Warfighting Symbology,” was published on 30 Sep. 1994.

The first major revision to the standard, MIL-STD-2525A, added nearly 1000 symbols and over 4500 symbol images. This document was published in Portable Document Format (PDF) on 15 Dec. 1996. During this period of revision, the Symbology home page was created to provide a site where the standard and other symbology products, along with low-resolution graphic depictions of all the symbols, can be viewed.

Eighty-five intelligence symbols and 425 images were added with Change One to MIL-STD-2525A. Change One completed SD-1 coordination in July 1997.

The current MIL-STD-2525B was released, effective 30 Jan. 1999 (http://symbology.disa.mil/symbol/mil-std.html). This is a standard which describes the symbology currently used by both the United States and NATO countries to plot and represent tactical situations in both war and other dangerous situations.

Significant information can be displayed through the 2525B symbology for any given situation on the battlefield or dangerous situations. For example:
Units, Equipment, Installations
Military Operations
METOC (Meteorology and Oceanography)
SIGINT (Signals Intelligence)
Mapping
MOOTW (Military Operations other than War)

The symbols used have a variety of attributes, modifiers and extensions to facilitate communications.

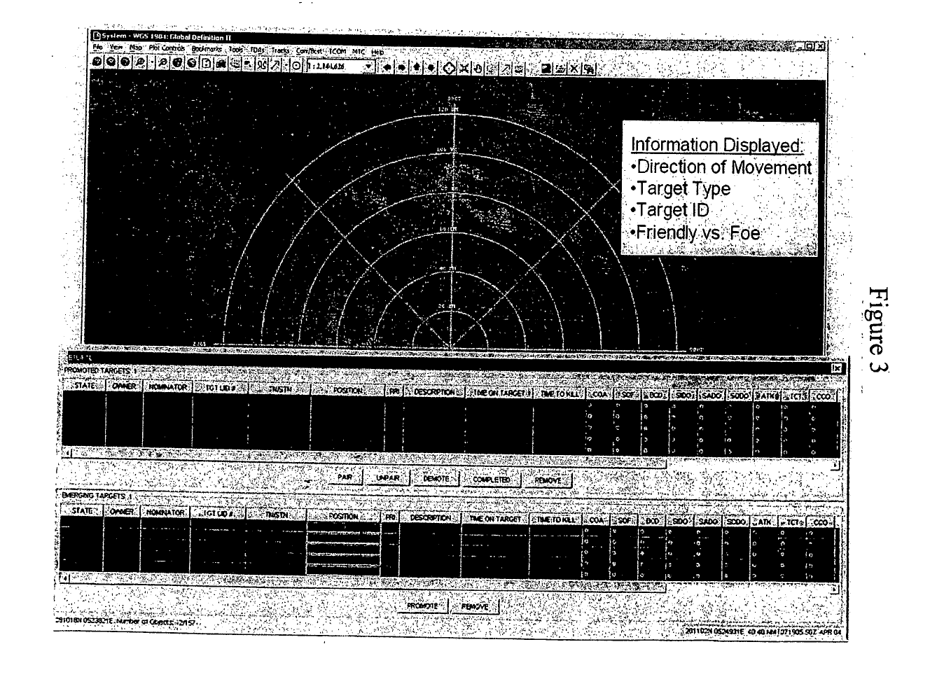

FIG. 3 shows the image of FIG. 2A with a target tracking display added to display information about targets in an area of interest on the display screen. Note that the display of target information covers a good deal of the map area. Nevertheless, visibility of such information is necessary to track both emerging targets (i.e. to those that are just coming to the attention of the user and in need of evaluation) and promoted targets (i.e. those identified as hostile and scheduled for engagement.)

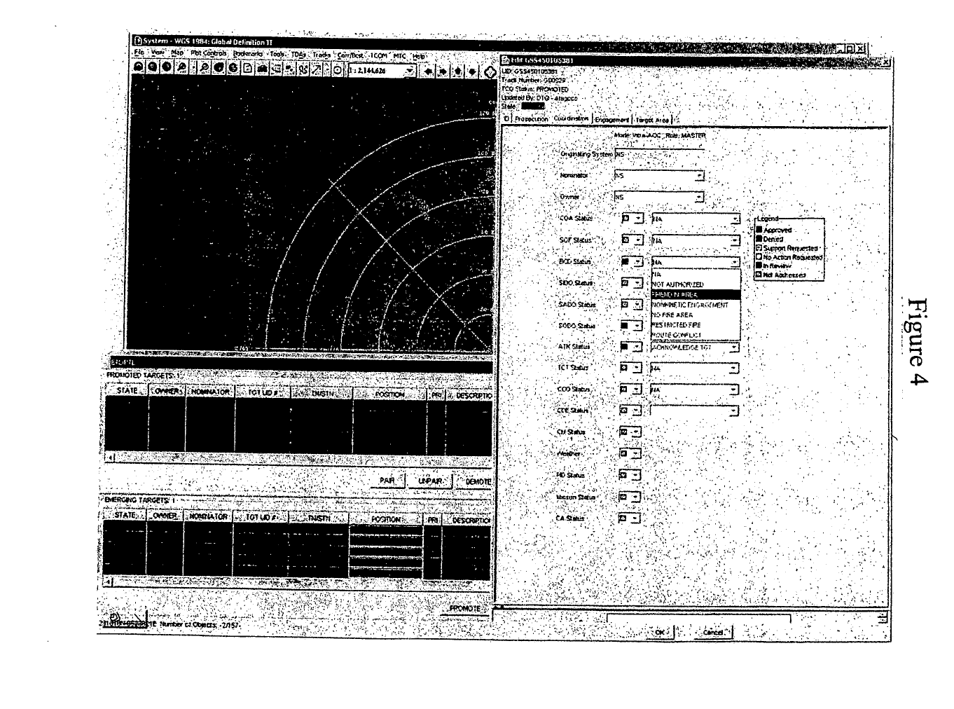

FIG. 4 shows the display screen of FIG. 3 with the addition of a target promoting display overlaid on the right half of the display screen. When an emerging target requires engagement, the target is promoted from the emerging target portion of the target tracking display to the promoted target portion. In order to do this, the user activates the target promoting display and fills in or selects the appropriate information. Note that this target promotion display involves integration of information from a large number of different sources, in order to insure that a target to be engaged is appropriate from, for example, political, military, civilian, collateral damage and other perspectives. This requires a coordination of information from a variety of different sources in order to insure the benefit of engaging the target exceeds the cost in terms of human life, and political consequences.

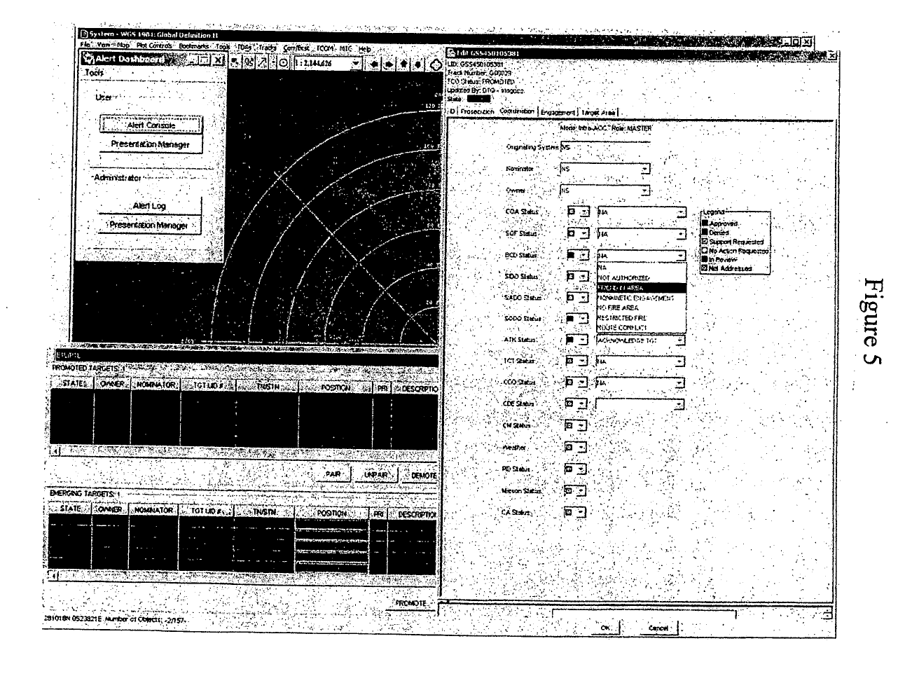

FIG. 5 shows a display screen of FIG. 4 with the addition of an alert-board in the upper left hand corner of the display screen. This allows the user or administrator to be automatically alerted to various conditions that may require their attention.

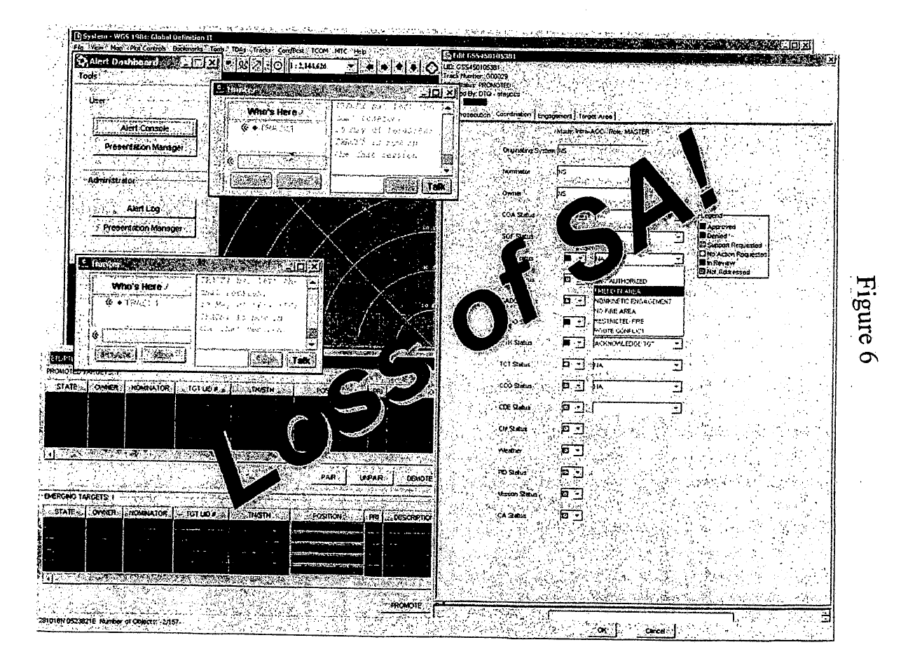

FIG. 6 shows the display screen of FIG. 5 with the addition of two chat session windows which substantially result in a loss of situational awareness (SA) on the part of a user. In short, what has happened is that the various display screens activated in order to do the users job result in totally obscuring a great portion of the information on the original targeting display, shown in FIG. 2A. As a result, the user cannot see what is occurring on the battlefield or other area of interest because of all the additional displays that are taking up the screen real estate. This results in a total loss of situational awareness, at least for a period of time.

When considering display technologies, it is important to consider the cognitive strengths and weaknesses of the human mind. The visualization techniques should exploit cognitive strengths where possible with an overall goal of reducing cognitive loading so that higher-level problem-solving skills can be used more effectively. For instance, the human brain has the ability to rapidly differentiate and process meanings for a specified set of shapes and colors. Therefore, if the visualization technique can effectively present data utilizing shapes and colors, then the cognitive loading required between seeing and understanding data is reduced.

It is interesting to note that many aspects of the human visual-processing system are automatic. Being automatic means that other tasks can be performed at the same time—since automation does not require use of the conscious mind—and the automated processes are very quick. Contrast that with interpretation of presented data where much uninterrupted attention must be applied when simply translating the data into thoughts, mostly conscious in nature, which reduces any simultaneous problem solving capacity. But, if a visualization technique uses a system of graphics that removes the interpretation step of processing data, then the conscious thinking capability of the display operator can be applied directly to automatically understanding the visual representation of the data as it is being viewed.

This automatic processing takes place through “preattentive vision”, which refers to those visual operations that can be performed prior to focusing attention on any particular region of an image. These innate abilities allow operators to perform certain types of visual analysis very rapidly and accurately. This can include detection of specific elements with unique characteristics or patterns. Preattentive processing appears to occur automatically in the human's low-level vision system. The processing generally takes less than 200 to 250 milliseconds-fast when you consider that eye movements take around 200 milliseconds.

Preattentive processing precedes the entry of input (stimuli) into conscious awareness. The preattentive processed items do not have to enter into the conscious processing; however they can cause an “awareness” event within the consciousness that something important needs attention. According to William James, the body is assailed with stimuli that compete for our conscious attention. If they were not managed, we would be paralyzed trying to process them. Instead, there is a concept of the “focus of attention” whereby some stimuli are automatically processed (preattentive), some are ignored, and others are selected (within the “focus of attention” mechanism) to enter our awareness—thereby enabling an effective interaction with the world.

Research in this area has found that the stimulus must be programmed in long term memory in advance of the preattentive processing. Once this training has occurred, various stimuli from different channels are preattentively analyzed in a fast, parallel, automatic fashion, with little mutual interference, up to the point where each stimulus is matched to its previous traces in long-term memory. This automation enables a simple analysis of the stimuli's meaning or significance with minimal cognitive loading. Maintaining processing at a lower level allows the full capacity of creative problem solving at the conscious level. If any of the observed objects shows a pattern that long-term memory has traced as something to be concerned about, then the attention focuses immediately—it only becomes aware of a specific thought or event if the significance of an event causes a concern.

The significance of this capability is that if a visualization technique can be created that has specific patterns that can be imprinted into memory (by simply looking at the pattern and determining what the pattern means or what significance it has), then, instead of the operator consciously assessing the significance of each item with each reading of the visualization, the operator processes the significance of each item preattentively with a glance of the visualization. The visualization will not have to be consciously watched once that level of imprinting has occurred. This is believed to be the strategy that transforms reading from processing individual symbols (letters) to create a “word” (with meaning in long term memory) to reading the “word” by processing the meaning of the word without having to consider the individual symbols (letters).

Donald Norman addressed similar cognitive themes when addressing the somewhat difficult interaction that exists between people and technology. (Norman, Donald A. Things that make us smart: Defending human attributes in the age of the machine, Reading, Mass., Addison Wesley, 1993) He presents two types of human cognition: “Experiential” and “Reflective.” He defines Experiential cognition as a mode of thinking that “ . . . leads to a state in which we perceive and react to the events around us, efficiently and effortlessly” (p. 16). It is the mode of our most expert behavior, based on training and experience such as when a pilot reacts automatically and immediately to a given situation based on prior experience and stored information. Experiential cognition is primary in nature, occurring when a particular experience requires no secondary analysis or reflection by the individual.

Reflective cognition, on the other hand, it a mode of thinking that includes conscious comparison and contrast during decision-making and idea formation. Norman states that reflective cognition “ . . . is the mode that leads to new ideas and novel responses” (p. 16). Reflective cognition is secondary in nature, occurring when deeper consideration and analysis is applied to the initial thoughts and experience resulting from a particular experience (i.e., the experience is reflected upon).

Both are important aspects of the human-machine interface, however, one area in which technologies fail is that they force significant conscious processing just to understand what is being presented, only allowing enough time for experiential cognition on the presented data, but not reflective cognition. Norman suggests that reflective cognition enables people to attain higher-level thinking where cognitive growth and innovation are most likely to occur. Therefore, the more conceptual knowledge we can quickly convert into “experiential” knowledge (which requires less conscious thought) through advanced visualizations, the more we will enable higher order reflective thought and human ingenuity.

Cognitive loading is correspondingly higher for situations where rules and training are not directly applicable when reacting to specific input from our surroundings. Therefore, it would be beneficial for visualization technology to provide the ability to “shift down” higher cognitive class tasks into less consciousness consuming class tasks, e.g. viewing numerous tracks on a COP to determine if any are in engagement range (requiring significant cognitive attention-looking at friend and foe, distances between tracks, weapon type for range determination, mission status (hunting, returning, armed, etc.), or simply looking at a specific track and “understanding” that it is within engagement range (shifting down from the Knowledge class to the Skill class).

Graphical visualizations are typically better for interpretation of information than textual representations. However, current visualization techniques demonstrate multiple weaknesses. They consume too much display real estate, they are unable to handle more than a few dimensions of data and they fail to capitalize on the powerful cognitive abilities of the human mind. To overcome the problems of the prior art, the invention utilizes a visualization language called GIFIC®, or Graphical Interchange For Information Cognition.

GIFIC® uses graphic symbols with specific colors and location-constructs to define various states of data. Such symbols are called Knowledge Enhanced Graphical Symbol or KEGS®. The states can include the representation of a baseline (expectation value) plus the difference from baseline (knowledge) into the symbol. The states can also represent non-numeric driven information such as track condition status (has fuel, has weapons) and mission status (engaging, seeking, returning) represented via pre-defined graphical patterns within the symbol. The KEGS® can also represent important aspects of the data not available in other graphical constructs including:

Data that is “old” or aged due to a planned refresh not being provided
Data that is missing (due to system failure)
Data that is missing (not due to system failure, such as scheduled maintenance or down time)
Data that is out of paradigm (not the same type, out-of-range, incompatible types)

In order for the human mind to attain pre-attentive abilities (with the associated reduction of cognitive loading), it must first imprint patterns into long-term memory. KEGS® by themselves establish a foundation for these patterns but to formulate more significant and imprintable patterns, several of the KEGS® may be combined to formulate an overall concept containing the necessary dimensions of the data required for understanding and decision making. GIFIC® supports that construct in the form of a Kegset™. A Kegset™ combines multiple KEGS® to form a specific shape that is fixed in layout (like forming word shapes with characters with the English language).

How this is accomplished in accordance with the invention will now be described in more detail.

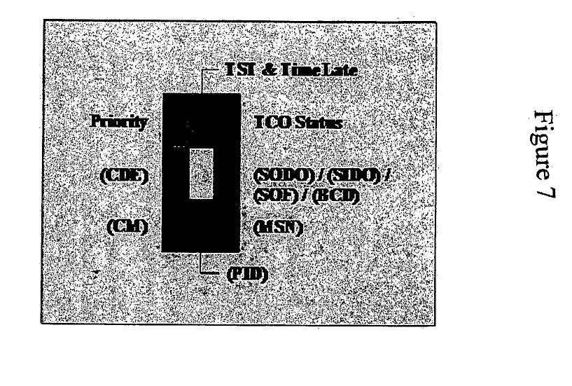

FIG. 7 illustrates a Kegset™ for replacing the displays that obscured an operator's situational awareness in accordance with one aspect of the invention. FIG. 7 shows a Kegset™ comprised of eight individual KEGS®.

Each of those KEGS® will now be discussed in somewhat greater detail.

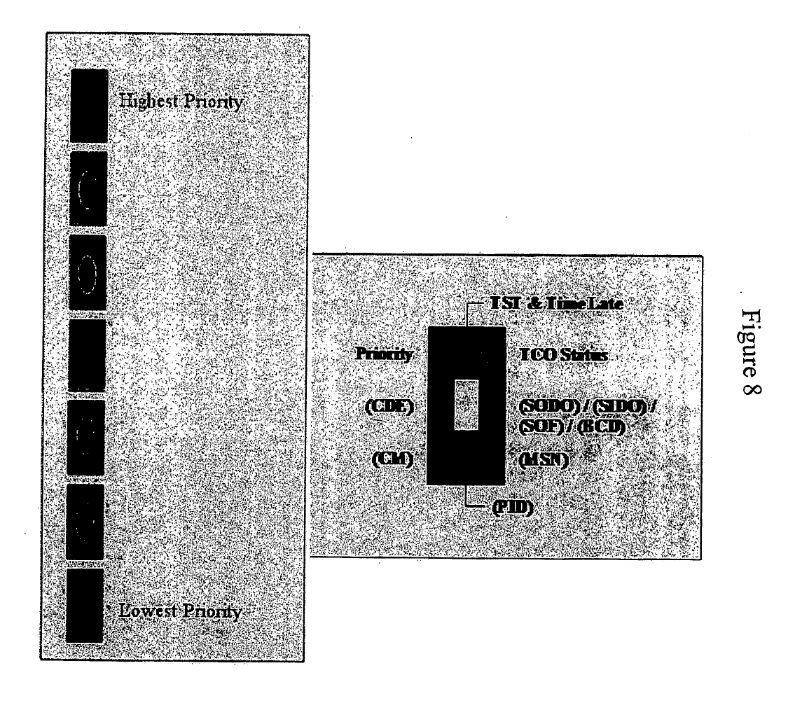

FIG. 8 illustrates exemplary semantics associated with the “Priority” KEGS® of the Kegset™ of FIG. 7 in accordance with one aspect of the invention. The Priority KEGS® in the upper left hand corner reflects the priority to be associated with the target. FIG. 8 shows the various states in which the Priority KEGS® can, in this example, display.

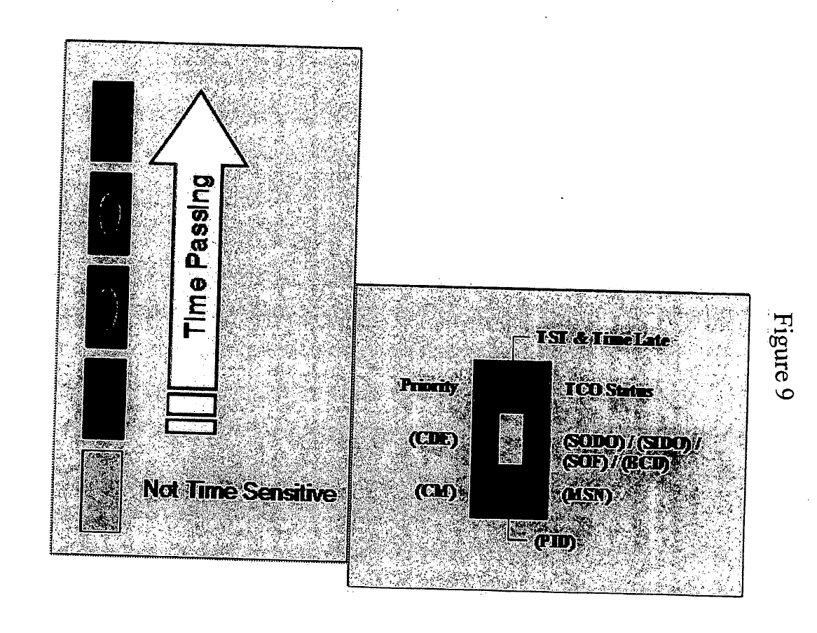

FIG. 9 illustrates exemplary semantics associated with the “TST and Late” KEGS® of the Kegset™ of FIG. 7 in accordance with one aspect of the invention. The TST and late KEGS® of the Kegset™ indicates the degree of urgency required in addressing a particular target. If a target is about to pass out of range, it must be addressed promptly or the opportunity will be lost. On the other hand, if there is some information that is not at all time sensitive and will be indicated as shown on the figure. Between the two extremes, various gradations are defined.

FIG. 10 illustrates exemplary semantics associated with the “TCO Status” (or Tactical Combat Operations Status) KEGS® of the Kegset™ of FIG. 7 in accordance with one aspect of the invention.

The TCO status KEGS® shows a state of the operations for the target. If an operator, for example, were to be searching for the target, the lowest level of status or “find” would be indicated. Once the operator had determined that the target actually represents a target, that status will be depicted. Once an asset has been paired up with the target, that status will be depicted and once the target is engaged that, too, will be depicted with a different symbology and finally once the attack is complete a damage assessment is undertaken to see if the mission was completed successfully.

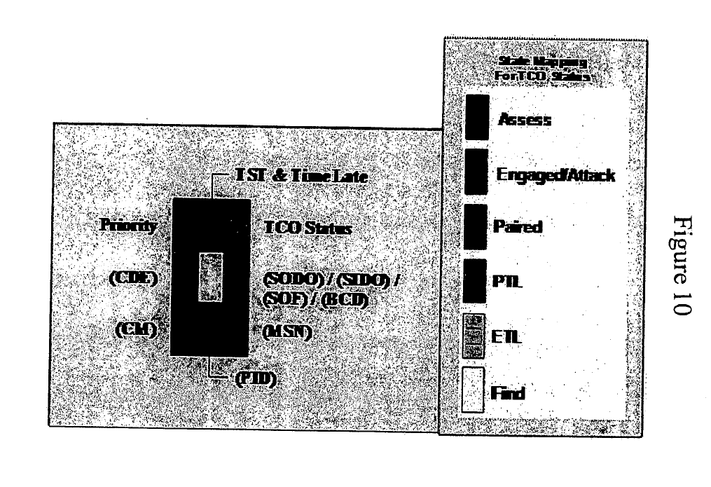

FIG. 11 illustrates exemplary semantics associated with the “CDE” KEGS®. CDE stands for collateral damage estimate. In short, an assessment is made prior to attack of the amount of collateral damage that might be sustained by the environment surrounding the target. In addition to “approved” or “denied” status, the KEGS® can indicate that the collateral damage estimate is under review or a supporting request has been filed. If it has not been addressed at all, it will be indicated by the color of the KEGS®.

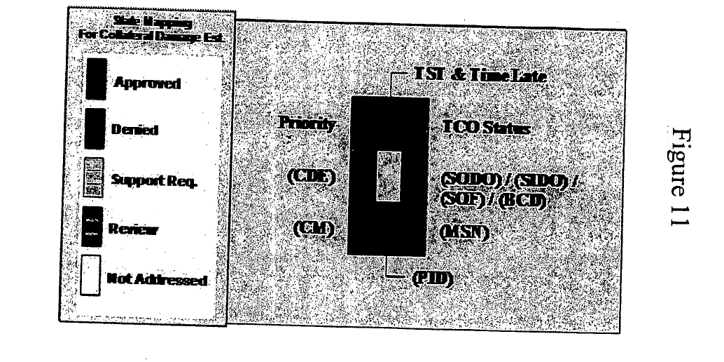

FIG. 12 illustrates exemplary semantics associated with the “(SODO)/(SIDO)/(SOF)/(BCD).” This shows the use of an aggregating KEGS® and exemplary semantics for each KEGS® forming the aggregate KEGS® in accordance with one aspect of the invention. In the case of FIG. 12, four military commands are involved in determining whether or not to approve the mission. Each of those commands will set an individual status showing the nature of their processing of the request for approval of the mission. If any one of those commands is in a status other than approved, the non-approved status will be reflected not only in the KEGS® of the individual command but also in the aggregate KEGS® of the aggregating Kegset™. By clicking on the aggregating KEGS®, the subordinate KEGS® used in formulating the status of the aggregating KEGS® can be viewed by clicking on the aggregating KEGS®. In such case, a display like that shown on the right hand side of FIG. 12 will be expanded so that the details that go into the decision constituting the semantics of the overall aggregating KEGS® can be individually identified.

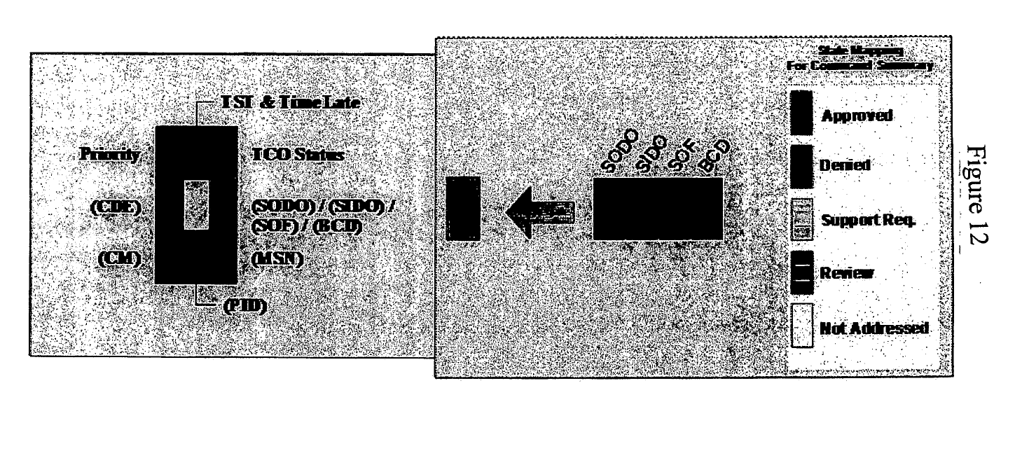

FIG. 13 illustrates how an authorized user can change the state of the KEGS® associated with his command in accordance with one aspect of the invention. Once the aggregating KEGS® has been expanded and the KEGS® constituting the decision and status of the aggregating KEGS® displayed, an authorized user may click on the KEGS® associated with his command and make changes to the status or enter status information for the first time using the drop down menus shown in FIG. 13.

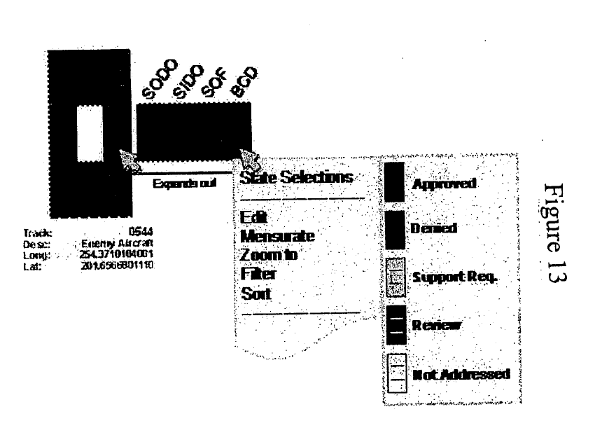

FIG. 14 illustrates exemplary semantics for each of the “(CM)” or Imagery Collection Management Status, “(PID)” or Positive ID Status, and “(MSN)” or Mission Status KEGS® of the Kegset™ of FIG. 7. These KEGS® constitute the bottom row of KEGS® in the Kegset™ of FIG. 7.

The data presented in the Kegset of FIG. 7 represents the data necessary for one specific station of a military operation in the context of the global information grid. It replaces all of the overlay screens previously mentioned with the graphical representation as shown in FIG. 7 and applied to the COP as shown in Figure

To this point, the use of KEGS® and a Kegset™ in providing a common operational picture has been directed to a military use in the context of the global information grid. However, common operational pictures can be useful in non military applications. KEGS and Kegsets also solve the aforementioned display issues presented in other information displays, such as business dashboards, scorecards, process monitors, to control-room displays.

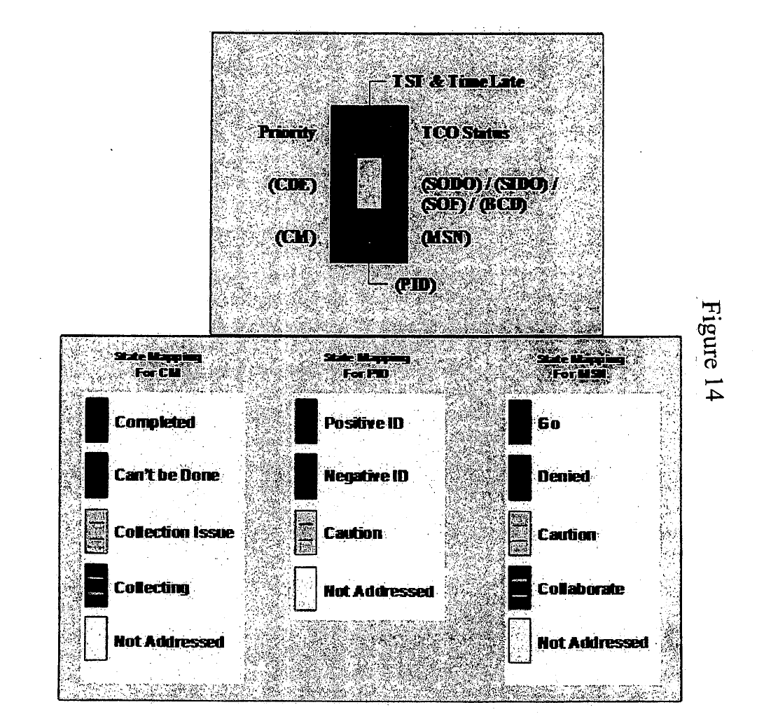

FIG. 15 shows a Kegset™ that is designed to be used in a common operational picture to represent one of possibly many facilities to monitor a facility's supply chain status.

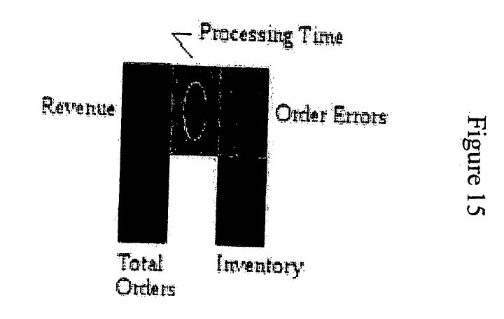

FIG. 16 illustrates a set of semantics suitable for use with the common operational picture of the state of facilities of the type shown in FIG. 15.

Considering FIG. 15, the color of the “total orders” and “inventory” KEGS® show that both of those are within expectations for the depicted facility. However, for the facility illustrated in FIG. 15, one sees that the revenue is “moderately below expectations” from the chart shown in FIG. 16. Similarly, the processing time required, in this example to produce a unit item from the supply chain, is “moderately above expectations”. Finally, the “Order Errors” KEGS® shows that the status of that facility in terms of order errors is severely above expectations. Thus, at a glance, one can tell the supply chain status of a facility utilizing the Kegset™ shown in FIG. 15. When a plurality of these Kegsets™ are utilized, perhaps overlaid across a map of the United States in such a way as to reflect their position in the country, with a quick glance, a common operational picture of the status of each of those facilities can be obtained. At a pre-attentive level, if each KEGS® of the Kegset™ is completely green, or even not green but not displaying a pattern that could be considered a problem, then that facility is within expectations and all respect and one need not bother to analyze the individual KEGS® forming the Kegset™. However, as soon as a non-completely green KEGS® or other pattern considered a problem shows up in the Kegset™ for a particularly facility, the kind of problems experienced by that facility are readily apparent.

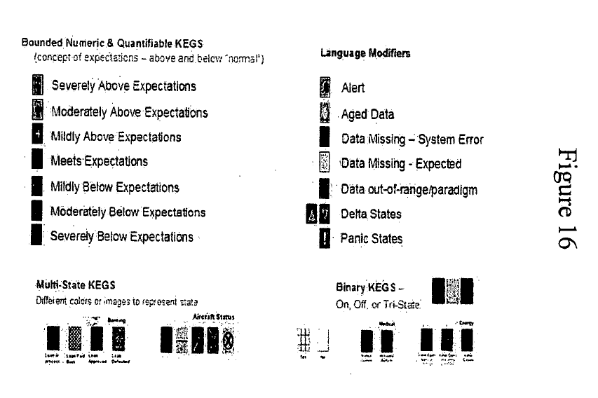

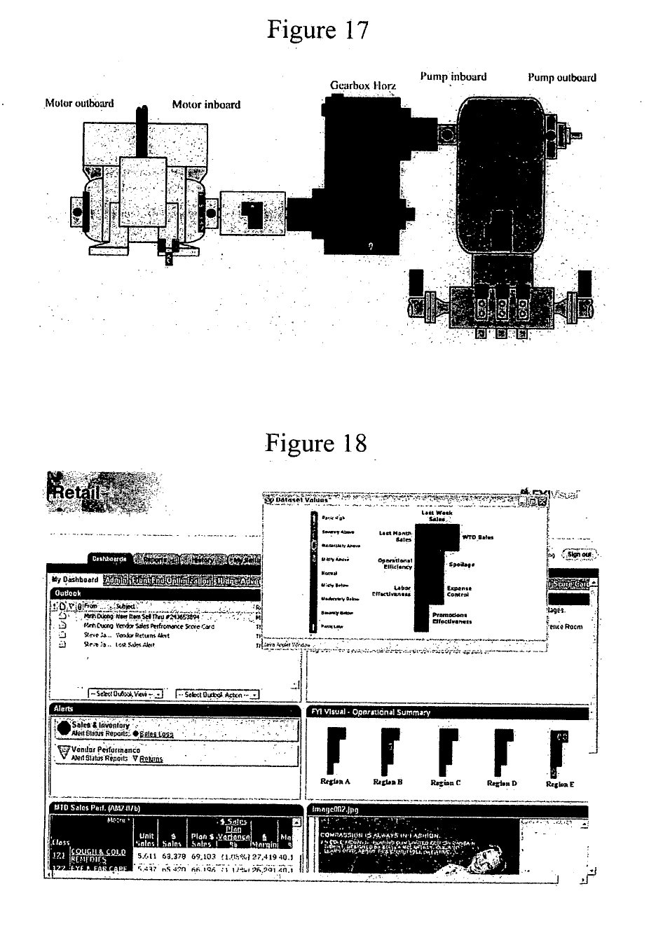

Other examples of non-military uses of common operational pictures are shown in FIGS. 17-20.

FIG. 17 shows a COP of status of a motor driven pumping station. One can see at a glance that the bearing on the inboard side of the motor is experiencing difficulty, i.e. vibration exceeding expectations.

FIG. 18 shows a COP of the status of 5 sales regions. One can rapidly assess which regions differ from expectations.

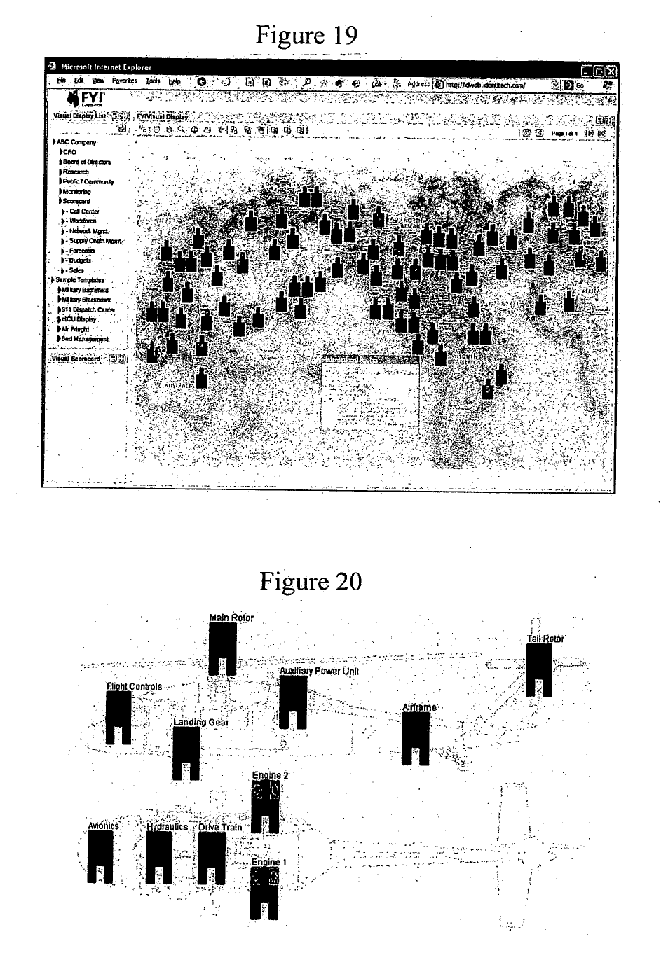

FIG. 19 shows a COP of the status of international routes. Routes differing from expectations are immediately visible.

FIG. 20 shows a COP of a helicopter with the status of several important systems represented by Kegsets™.

Thus, through the use of a plurality Kegset™s as indicated, a user can rapidly acquire situational awareness of the depicted common operational picture of the system represented. The use of the GIFIC® language using KEGS® and Kegset™s in this manner, allows pre-attentive processing of information allowing the user to rapidly focus on significant information without being distracted by evaluating information that requires no attention at the common operational picture level.

Thus, the application of KEGS® and Kegset™ using the GIFIC® language to represent a common operational picture of a system being represented, results in much greater efficiency on the part of a user and understanding the situation and in responding appropriately to the situation as it dynamically changes.

While various embodiments of the present invention have been illustrated herein in detail, it should be apparent that modifications and adaptations to those embodiments may occur to those skilled in the art without departing from the scope of the present invention as set forth in the following claims.

What is claimed is:

1. Apparatus for displaying a common operational picture, comprising:
a. a communications port for accessing information contained in a database;
b. a processing element to request and receive information from said database relevant to a geographic location of interest;
c. a display for displaying a common operational picture using said information by representing an element type of the common operational picture as a plurality of knowledge enhanced graphical symbols.

2. The apparatus of claim 1 in which multiple elements of said element type are displayed on the display of the common operational picture.

3. The apparatus of claim 2 in which the common operational picture contains at least one element taken from the group of symbols defined in MIL STD 2525.

4. The apparatus of claim 3 in which at least one element from the group of symbols defined in MIL STD 2525 is supplemented with knowledge enhanced graphical symbols.

5. A system for displaying a common operational picture, comprising:
a. a plurality of sensors;
b. a database receiving and storing information from said plurality of sensors;
c. a plurality of user terminals connected to said database; at least one user terminal comprising
c1. a processing element to request and receive information from said database relevant to a geographic location of interest; and
c2. a display for displaying a common operational picture by representing an element type of the common operational picture as a plurality of knowledge enhanced graphical symbols.

6. The system of claim 5 in which said sensors include at least one sensor selected from the group consisting of a satellite sensor, an unmanned aerial vehicle, a pressure sensor, a vibration sensor, a human sensor, a communications intercept, an aircraft sensor, and a camera.

7. The apparatus of claim 5 in which multiple elements of said element type are displayed on the display of the common operational picture.

8. The apparatus of claim 5 in which the common operational picture contains elements taken from the group of symbols defined in MIL STD 2525.

9. The apparatus of claim 8 in which elements from the group of symbols defined in MIL STD 2525 are supplemented with knowledge enhanced graphical symbols.

10. A method of displaying a common operational picture comprising the step of representing an element type of a common operational picture as a plurality of knowledge enhanced graphical symbols.

11. The method of claim 10 in which multiple elements of the element type are displayed on the display of the common operational picture.

12. The method of claim 11 in which the common operational picture contains elements taken from the group of symbols defined in MIL STD 2525.

13. The method of claim 14 in which elements from the group of symbols defined in MIL STD 2525 are supplemented with knowledge enhanced graphical symbols.

14. A computer program product, comprising:
a. a memory medium; and
b. computer controlling instructions, stored on said memory medium, for displaying a common operational picture by representing an element type of a common operational picture as a plurality of knowledge enhanced graphical symbols.

15. The computer program product of claim 16 in which said instructions cause multiple elements of the element type to be displayed on the display of the common operational picture.

16. The computer program product of claim 14 in which the display of the common operational picture contains elements taken from the group of symbols defined in MIL STD 2525.

17. The method of claim 16 in which at least some elements from the group of symbols defined in MIL STD 2525 are supplemented with knowledge enhanced graphical symbols.
